(19) United States
(12) Patent Application Publication
(10) Pub. No.: US 2012/0246738 A1
(43) Pub. Date: Sep. 27, 2012

(54) Resource Sharing and Isolation in Role Based Access

(75) Inventors: Shon Kiran Shah, Redmond, WA (US); William L. Scheidel, Seattle, WA (US); Anand Shankar Sarda, Redmond, WA (US); Gokcen Iskender, Redmond, WA (US); Lloyd Giberson, Kirkland, WA (US); Evan Michael Keibler, Bellevue, WA (US); Tolga Yildirim, Sammamish, WA (US)

(73) Assignee: Microsoft Corporation, Redmond, WA (US)

(21) Appl. No.: 13/052,313

(22) Filed: Mar. 21, 2011

(51) Int. Cl. G06F 21/00

(52) U.S. Cl. 726/28

(57) ABSTRACT

The subject disclosure is directed towards resource sharing and/or isolation in a role based access (RBA) system. A resource may be associated with an owner, via an owner property, which provides isolation by enforcing exclusive access to that resource by the owner (unless the owner chooses to share). Sharing is provided by allowing the owner to identify, in a GrantedTo list, selected receiving user(s) or user role(s) that can have shared access. Also described is administrator-level control over the ability to share resources and/or receive shared resources, e.g., an administrator selects whether a resource owner is permitted to share resources and/or whether receiving users/user roles are permitted to receive shared resources.

### BACKGROUND

Role Based Access (or RBA, sometimes referred to as role-based access control, or RBAC) refers to a technology in which access to computer resources (e.g., objects) is controlled based on user roles. In general, a user role defines one or more actions that can be taken, a scope of resources on which the actions can be taken, and the users (which may include groups), generally referred to as members, that can take the actions on the resources. For example, a user role may define the actions of starting and stopping virtual machines, specify which virtual machines may be started and stopped (the scope), and identify which members can take those allowed actions on those specified virtual machines.

Role based access enables effective management and enforcement of security policies that can vary among enterprises. However, role based access significantly limits enterprise administrators with respect to having to provide or not provide more selective resource access. For example, users in different user roles cannot access a resource unless the administrator grants access to both user roles, which is often not desirable because doing so also grants access to any other members in those roles. Similarly, if a resource is in the scope of a user role, all members of that role have access to the resource, which is not always desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which access to a resource may be shared with specified other receiving entities (e.g., users or user roles) outside of a user role, and/or a resource may be isolated from other users in the user role by specifying an exclusive user owner. In one aspect, information is associated with a resource (e.g., by an administrator) that identifies an owner of that resource. In one aspect, the owner may name a set (e.g., a list) of zero or more receiving entities that are granted shared access to that resource.

Upon receiving a request to access an owned resource, an authorization mechanism evaluates whether the request is from the owner or from a user that corresponds to an entity in the set. Access is denied to any other user in that user's user role; (note however that users in parent user roles may still have access to this resource). Isolation is provided by naming an owner while not naming an entity in the set. Sharing is provided by naming an owner while including at least one entity in the set that gets shared access to the resource. Actions provided in conjunction with the access request are allowed if the requestor has the permission to perform the action on the resource.

In one aspect, information may be associated (e.g., by an administrator) with the owner indicative of whether the owner is permitted to share the resource. This may be on a user role basis, e.g., the owner belongs to a user role, and members of the user role are permitted to share all owned resources, or share no owned resources.

In one aspect, information may be associated (e.g., by an administrator) with a member indicative of whether the user is permitted to receive shared resources. This may be on a user role basis, e.g., the member belongs to a user role, and members of the user role are permitted to receive shared resources, or receive no shared resources.

The list that allows sharing may be built based upon the sharing and receiving permissions. For example, the owner can only add names if the owner is permitted to share resources, and the name can only be added if the named entity is permitted to receive shared resources.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example role based access system configured to provide resource isolation and resource sharing.

FIG. 2 is an example representation of a user role hierarchy exemplifying sharing across users/different user roles.

FIG. 3 is a representation of an example user interface that facilitates association of an owner and receiving entities with a user resource.

FIGS. 4 and 5 comprise a representation of an example flow of operations related to resource access, including operations directed towards determining whether to authorize a user to perform an action on a resource.

FIG. 6 is a flow diagram representing example steps for determining whether to allow a requested action for a given user request with respect to a resource.

FIG. 7 is a representation of an example user interface that allows an administrator to set whether a user role's members can share resources, or receive shared resources, or both.

FIG. 8 is a block diagram representing exemplary non-limiting networked environments in which various embodiments described herein can be implemented.

FIG. 9 is a block diagram representing an exemplary non-limiting computing system or operating environment in which one or more aspects of various embodiments described herein can be implemented.

### DETAILED DESCRIPTION

Various aspects of the technology described herein are generally directed towards including sharing and/or isolation mechanisms and techniques in a role based access (RBA) system, which provide for resource sharing (shared resource access across user roles) and resource isolation (selective resource access within a user role). In one aspect, resources are each associated with a maintained “GrantedTo” list that contains information about users with whom that resource may be shared. Each resource also may be associated with a maintained “Owner” property that contains identifier information about which user has exclusive access (within the user role) to that resource, including for the purpose of any resource sharing. As will be understood, the GrantedTo list provides for resource sharing, while the Owner property provides for resource isolation.

In one aspect, there is also described administrator-level control over the ability to share resources and/or receive shared resources. An administrator selects whether a resource owner (e.g., as part of a user role) is permitted to share the resource with another user, and/or whether members (e.g., of a user role) are permitted to receive shared resources from other user owners.

It should be understood that any of the examples herein are non-limiting. For one, while virtual machines and folders/files are used as examples of resources, other types of resources (e.g., database tables and/or portions of database tables, devices and so forth) may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and access considerations in general.

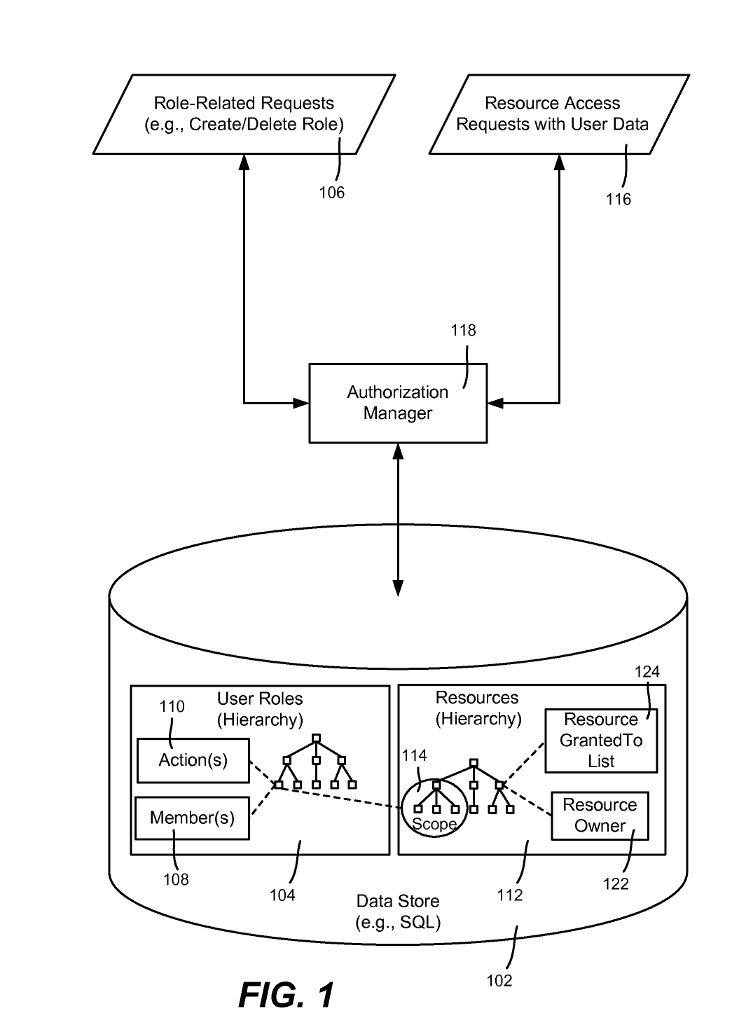

FIG. 1 shows example components for one role based access system, in an implementation in which a data store 102 (e.g., a SQL database) maintains the role based access information. User roles 104 in the data store 102 are created, deleted and otherwise controlled by administrator requests 106, such as to add one or more members to each user role, determine the actions and scope of each user role, and so forth. In this manner, each user role is arranged in a hierarchy under one or more administrator levels, and is associated in the data store 102 with one or more members (e.g., block 108) and one or more allowed actions e.g., (block 110). Note that although not shown in FIG. 1 for each user role represented in the hierarchy, in general each user role is associated with zero or more members, zero or more resources in the scope and zero or more actions, and there may be any practical number of user roles.

The resources 112 are generally represented in the data store 102 in a hierarchy of one or more levels, and each user role is further associated with a scope (a subset of that resource hierarchy) comprising zero or more resources assigned to the user role that can be accessed with respect to performing the allowed actions. The oval labeled 114 in FIG. 1 shows an example scope for one user role, such as for a hierarchy of folders/files, which are resources.

In general, role based resource access (action) requests 116 are handled by an authorization manager 118 or the like, which (assuming a known user) looks up information in the data store 102 to determine whether a requested action may be performed on a specified resource. In general the authorization manager 118 determines the user's user role or roles, whether the requested action is allowed for the user role and whether the resource is in the scope of the user role. In this way, during runtime, role based access-enabled applications may query the authorization manager 118, which determines resource access for a requested task from relationships maintained in the data store 102.

In known technologies, an entire user role either had access to the resource (to the extent of the allowed actions for that role), or did not. With the technology described herein, each resource has a resource owner property that may be populated to indicate a resource owner (e.g., block, 122), which provides for resource isolation, as described below. Further, each resource may have a “GrantedTo” list (e.g., block, 124) that allows other users (including non-members of the owner's user role) to be granted access by the owner to an owned resource, yet without providing anyone else (at the non-administrator level or levels) with access.

In one implementation, only a resource owner can share a resource with a receiving user or user role; (resource sharing and receiving abilities may be subject to administrator permission, as described below). In one implementation, the owner identified in the owner property is a single user within a user role who has exclusive access to the resource; (note that higher level administrators also have access, and thus “exclusive” refers to exclusive with respect to other user-level members). A higher-level administrator sets the owner property. In alternative implementations, more than one owner may be set, and/or a user role (or more than one) may be identified as an owner.

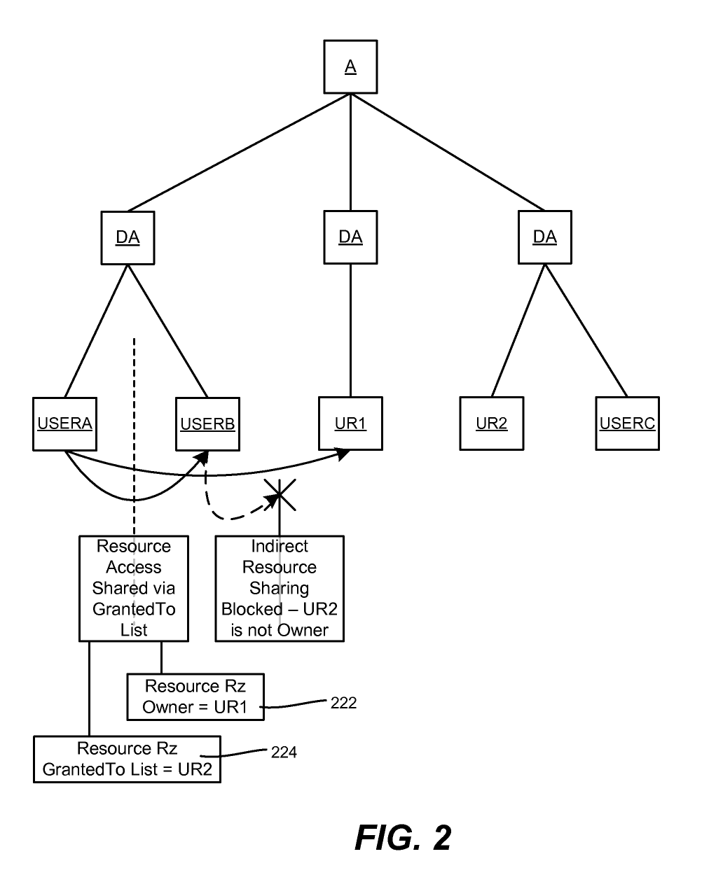

As is known and generally represented in FIG. 2, the user roles are arranged in a hierarchy, with the administrator (A) being the highest-level user and able to create or delete any lower roles. Below the administrator level, delegated administrators (DAs) may be created, and such administrators are able to perform some administrative-like actions, (e.g., create and delete other delegated administrator and user roles) but only within the scope defined in their delegated administrator user role.

Below the delegated administrators are users and user roles referred to as self-service and/or other user roles; (USERA-USERC and UR1 and UR2 are shown in this simplified example, however any practical number of users and/or user roles may be present). Note that in one implementation, members of user roles are unable to create new user roles.

As described herein and as generally represented in FIG. 2, a user (e.g., UR1) that is also an owner (block 222) of a resource may be able to add one or more other users or user roles to the GrantedTo list 224 for that resource, and thereby allow one or more other users and/or user role or roles (a receiving entity) access to that resource, even when the receiving entity (e.g., USERB) does not have that resource in its scope as long as the receiving entity has the resources' container in its scope. As conceptually illustrated in FIG. 2, resource access heretofore was unable to cross the dashed vertical line, but now can be via the GrantedTo list, as represented by the solid curved arrow. Note however that in one implementation, the resource cannot be further shared by the recipient user role or member, because only an owner (or higher-level administrator) can share an owned resource, and thus further access via indirect sharing is prevented. This is represented in FIG. 2 by the dashed curve line being blocked from indirect sharing.

In sum, the GrantedTo list comprises a list of users or user roles that receive shared access to the resource. Only the owner (or higher-level administrators) is able to change the GrantedTo list on a resource. Any user or user role that is added to the GrantedTo list basically receives access to the shared resource, and is able to perform any actions on that resource that are permitted by his or her user role; however an added user is not able to change the owner of the resource or share the resource further with any other user. This ensures that the original owner never loses control of the resource unless the owner specifically relinquishes it, or a higher level administrator intervenes. Note that the GrantedTo list is an inclusion model that allows for adding one or more others while excluding everyone else; it is feasible to also (or instead) have an exclusion mode that adds everyone except for excluded users and/or user roles.

Note that in one model, the user that receives access has rights to perform actions on the resource based on the receiving user's user role's allowed actions, not the owner's user role's allowed actions. For example, if an owner of a virtual machine resource only is allowed actions that can start and stop the virtual machine, and that owner shares the virtual machine resource with another user, that receiving user may, according to the receiving user's user role, perform a different set of actions on that virtual machine, such as to delete it. In alternative models, an owner can instead share resource access that is limited to only the set (or a chosen subset) of actions that the owner can perform. In another alternative, the owned resource can be shared with read-only access.

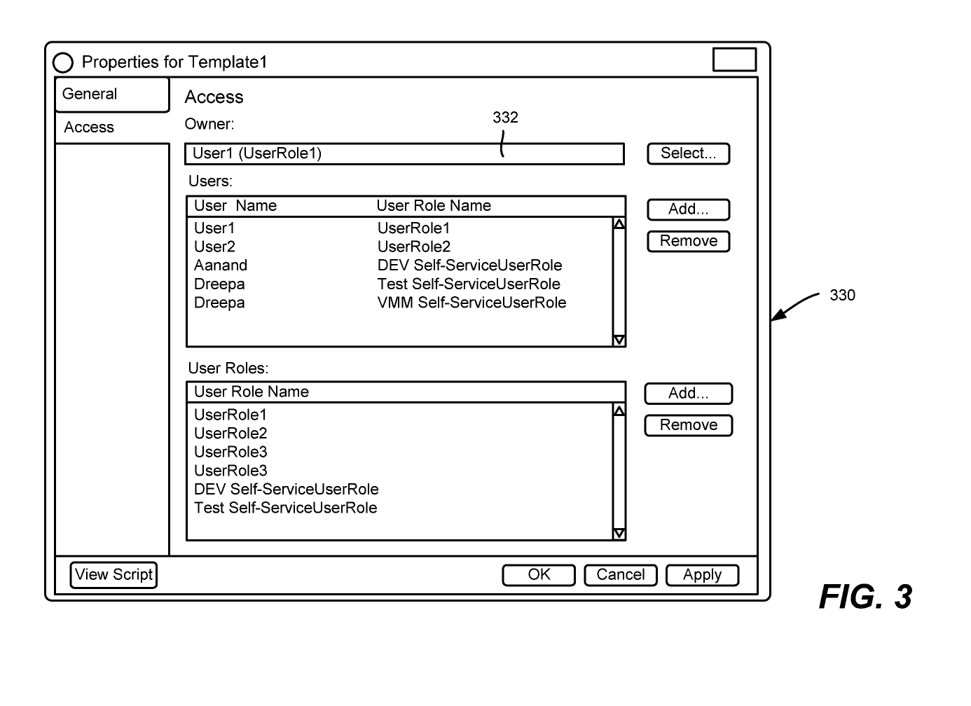

FIG. 3 is an example of a user interface 330 by which an administrator-level user can define an owner of a resource, which in one implementation only may be a single user. Note that it is feasible in an alternative implementation to identify multiple owners. A selection/input mechanism allows the owner to be specified, e.g., in the displayed area 332. Isolation is accomplished by identifying an exclusive owner, as described below; not assigning an owner to the resource provides conventional role based access. FIG. 3 also shows a selection/input mechanism to specify user or user role to add to resources' Granted To list.

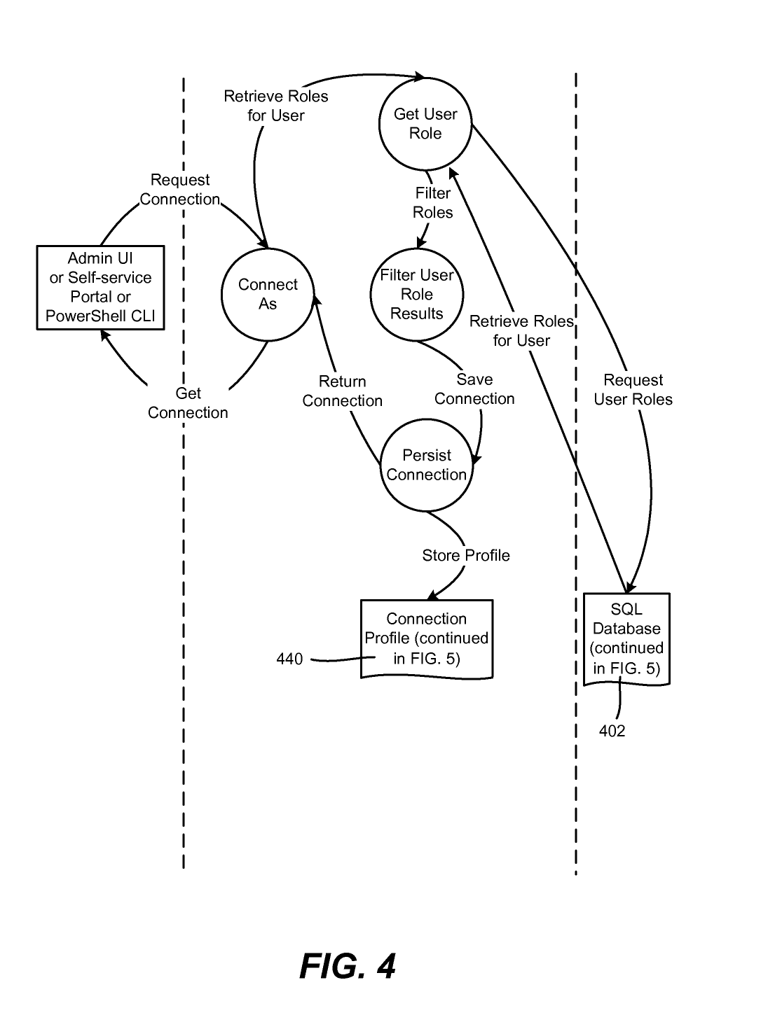

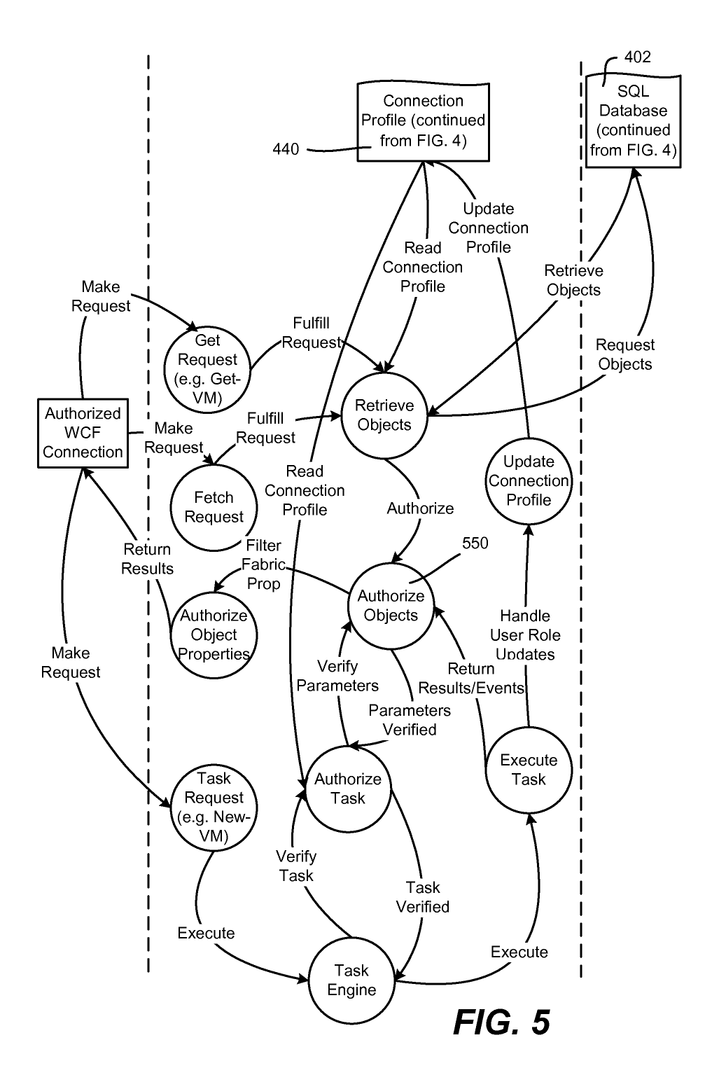

FIGS. 4 and 5 comprise a representation of an authorization mechanism, such as implemented in the authorization manager 118 of FIG. 1. As can be seen by following the diagram flow, based on the user identity at the time of connection and the information in the data store (SQL database 402 in this example), a connection profile 440 containing role information for a user (or administrator) is stored by the system for use in resource access or other operations. In FIG. 5, a request to access a resource (retrieved objects in this example) is authorized based on the information in the connection profile and the information associated with the resource, as represented by the authorize objects operation (the circle labeled 550).

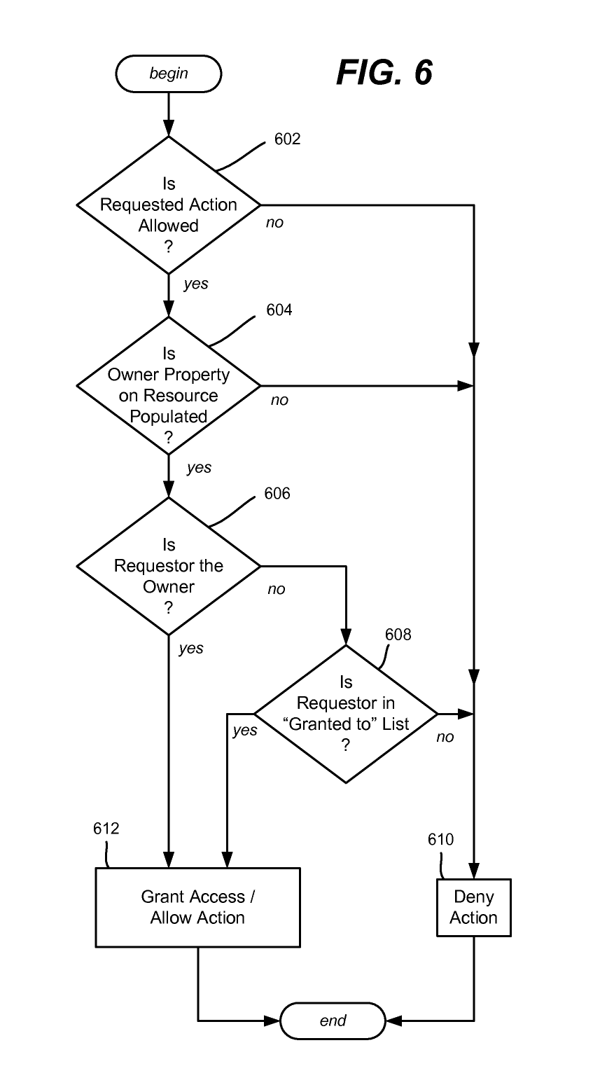

FIG. 6 shows general example logic of the authorize objects operation 550 for user roles that support isolation/sharing of resources (e.g., self-service users), beginning at step 602 where the requested action for this user is evaluated for whether it is allowed, e.g., whether this user can perform the requested action based on the action or actions associated with the user role. If not, the action is denied via step 610. Note that for user roles that do not support isolation/sharing of resources, the RBA model is generally unchanged, that is, access is granted when the requested action is allowed and the resource is in scope, otherwise it is denied.

If the requested action is allowed at step 602, step 604 evaluates whether an owner has been named for this resource. If there is no owner identified for this resource, the action denied at step 610. Note that other models are feasible, e.g., an empty owner property may be treated as if isolation/sharing is not supported for the resource, even though isolation/sharing is supported for the user role.

If the action is allowed and there is an owner, steps 606 and 608 evaluate whether the requestor is the owner, or is listed in the GrantedTo list, respectively. Note that this is shown as two decisions in FIG. 6, such as corresponding to an “OR” operation in the logic. If so, the action is allowed at step 612, otherwise it is denied at step 610. Note that if the owner information is populated, but the GrantedTo list is empty, the authorization manager authorizes access to the object only if the requesting user is the owner, which enables isolation.

Turning to another aspect, the administrator may control the sharing operations as desired by setting whether resource sharing is permitted by the owner, and/or whether receiving of a shared resource is permitted (to the receiving entity). This may be set at any time, including before any owner is associated with a resource.

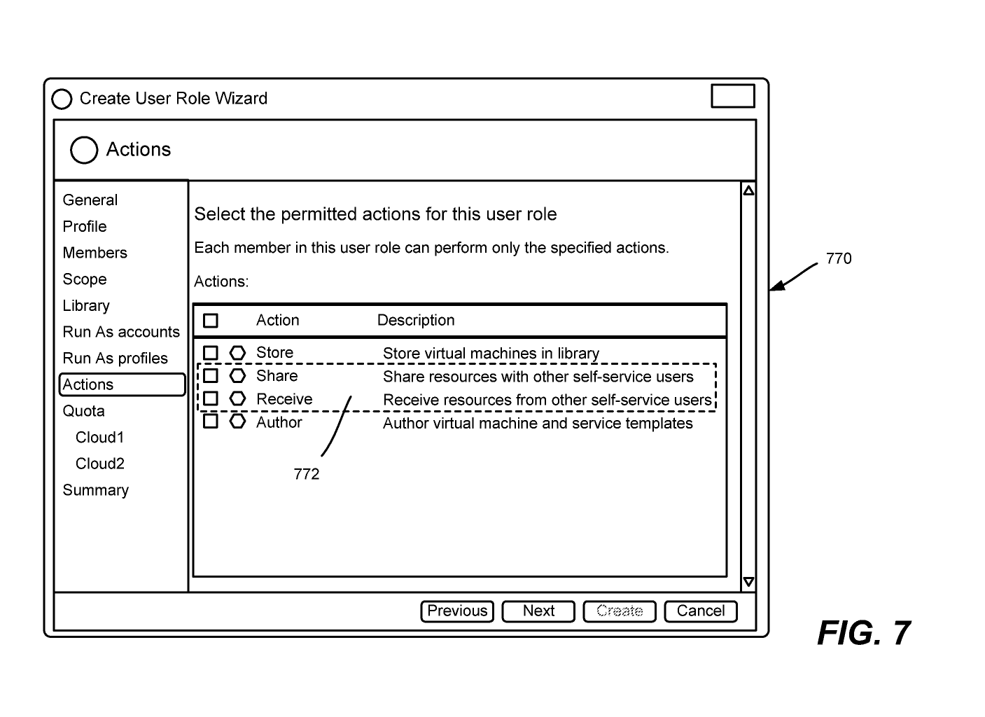

In one implementation, represented in the user interface 770 of FIG. 7, sharing and receiving are decided on a user role granularity level, e.g., the members of a user role are permitted to share resources or not, and/or are permitted to received shared resources or not, as set by the administrator via buttons or the like in the area within the highlighted area (not actual) dashed box 772. In an alternative implementation, sharing control may be on the per-user/member granularity level (as well as on the user role granularity level, if desired).

Thus, in one implementation, user roles that need sharing and isolation are set with share and receive permissions. A user can share resource only if his or her user role is permitted to share. Similarly a user can receive a shared resource only if his or her user role is permitted to receive. Share and receive permissions on user roles are set by higher level administrators, which enables administrators to maintain control over who can share and who can receive.

The GrantedTo list may be built based on this share permitted/receive permitted information, e.g., entered via the user interface 770 for user role granularity, (or a similar interface for a finer granularity). Only if the owner is allowed to share resources according to this administrator setting can there be a non-empty GrantedTo list associated with any of the owner's resources (unless the administrator adds an entity). Then, only if the named user or user role is allowed to receive shared resources according to his or her corresponding administrator setting, is the named entity allowed to be added by the owner to the GrantedTo list, for example.

As can be seen, to facilitate isolation and sharing, each shareable resource is associated with an owner property and GrantedTo list. The owner can share a resource with a receiving entity, subject to permission to share and permission to receive access as controlled by an administrator.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

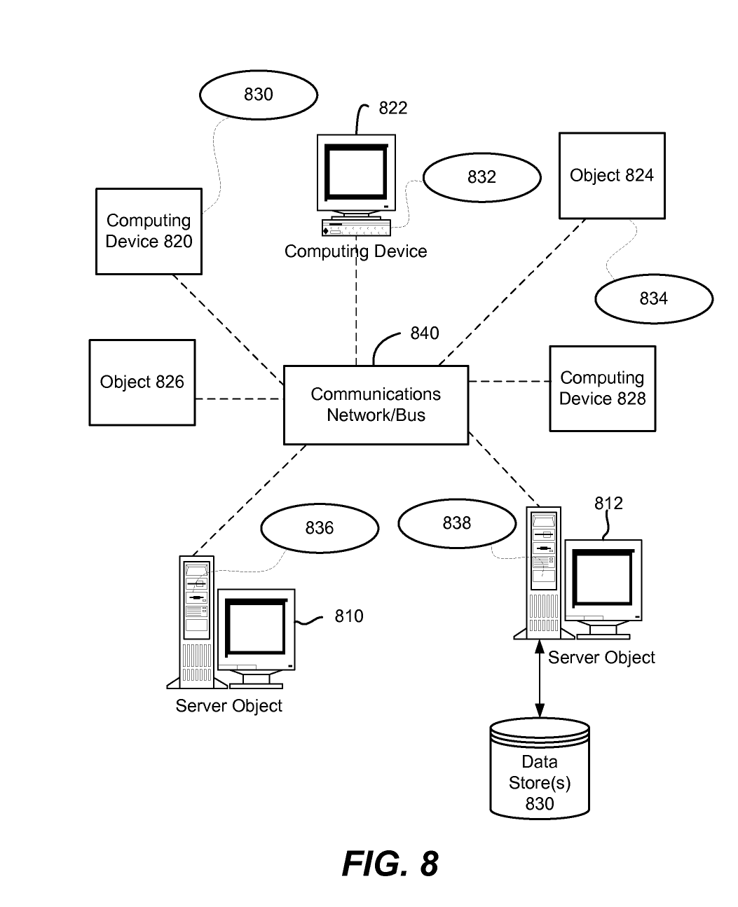

FIG. 8 provides a schematic diagram of an exemplary networked or distributed computing environment. The distributed computing environment comprises computing objects 810, 812, etc., and computing objects or devices 820, 822, 824, 826, 828, etc., which may include programs, methods, data stores, programmable logic, etc. as represented by example applications 830, 832, 834, 836, 838. It can be appreciated that computing objects 810, 812, etc. and computing objects or devices 820, 822, 824, 826, 828, etc. may comprise different devices, such as personal digital assistants (PDAs), audio/video devices, mobile phones, MP3 players, personal computers, laptops, etc.

Each computing object 810, 812, etc. and computing objects or devices 820, 822, 824, 826, 828, etc. can communicate with one or more other computing objects 810, 812, etc. and computing objects or devices 820, 822, 824, 826, 828, etc. by way of the communications network 840, either directly or indirectly. Even though illustrated as a single element in FIG. 8, communications network 840 may comprise other computing objects and computing devices that provide services to the system of FIG. 8, and/or may represent multiple interconnected networks, which are not shown. Each computing object 810, 812, etc. or computing object or device 820, 822, 824, 826, 828, etc. can also contain an application, such as applications 830, 832, 834, 836, 838, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 8, as a non-limiting example, computing objects or devices 820, 822, 824, 826, 828, etc. can be thought of as clients and computing objects 810, 812, etc. can be thought of as servers where computing objects 810, 812, etc., acting as servers provide data services, such as receiving data from client computing objects or devices 820, 822, 824, 826, 828, etc., storing of data, processing of data, transmitting data to client computing objects or devices 820, 822, 824, 826, 828, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 840 or bus is the Internet, for example, the computing objects 810, 812, etc. can be Web servers with which other computing objects or devices 820, 822, 824, 826, 828, etc. communicate via any of a number of known protocols, such as the hypertext transfer protocol (HTTP). Computing objects 810, 812, etc. acting as servers may also serve as clients, e.g., computing objects or devices 820, 822, 824, 826, 828, etc., as may be characteristic of a distributed computing environment.

### Exemplary Computing Device

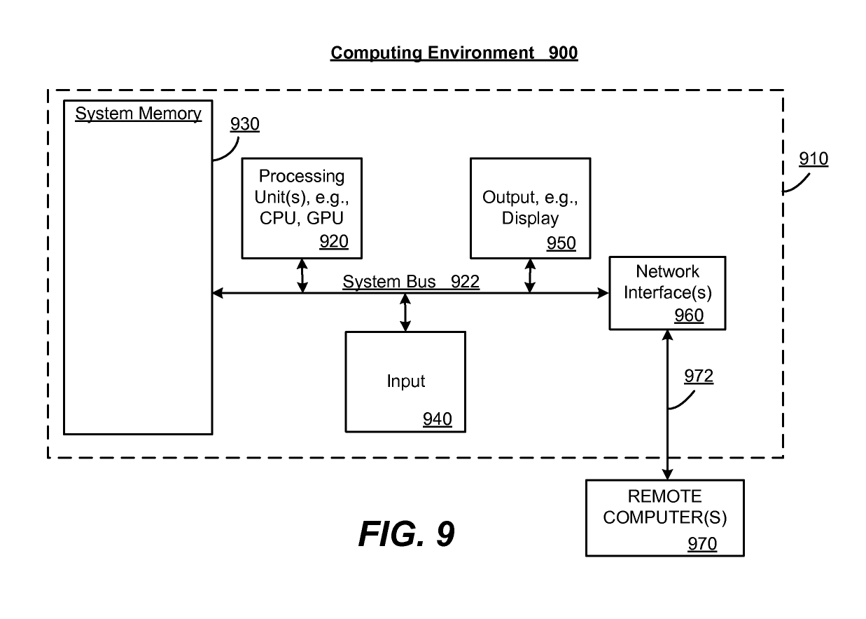

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 9 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 9 thus illustrates an example of a suitable computing system environment 900 in which one or aspects of the embodiments described herein can be implemented, although as made clear above, the computing system environment 900 is only one example of a suitable computing environment and is not intended to suggest any limitation as to scope of use or functionality. In addition, the computing system environment 900 is not intended to be interpreted as having any dependency relating to any one or combination of components illustrated in the exemplary computing system environment 900.

With reference to FIG. 9, an exemplary remote device for implementing one or more embodiments includes a general purpose computing device in the form of a computer 910. Components of computer 910 may include, but are not limited to, a processing unit 920, a system memory 930, and a system bus 922 that couples various system components including the system memory to the processing unit 920.

Computer 910 typically includes a variety of computer readable media and can be any available media that can be accessed by computer 910. The system memory 930 may include computer storage media in the form of volatile and/or nonvolatile memory such as read only memory (ROM) and/or random access memory (RAM). By way of example, and not limitation, system memory 930 may also include an operating system, application programs, other program modules, and program data.

A user can enter commands and information into the computer 910 through input devices 940. A monitor or other type of display device is also connected to the system bus 922 via an interface, such as output interface 950. In addition to a monitor, computers can also include other peripheral output devices such as speakers and a printer, which may be connected through output interface 950.

The computer 910 may operate in a networked or distributed environment using logical connections to one or more other remote computers, such as remote computer 970. The remote computer 970 may be a personal computer, a server, a router, a network PC, a peer device or other common network node, or any other remote media consumption or transmission device, and may include any or all of the elements described above relative to the computer 910. The logical connections depicted in FIG. 9 include a network 972, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, determining access to a resource in a role-based access system, including associating information with a resource that identifies a set of zero or more receiving entities that are granted shared access to the resource, receiving a request to access the resource from a user that corresponds to an entity in the set, and allowing access to the resource based upon evaluating the requesting user with respect to the set.

2. The method of claim 1 further comprising, allowing access to the resource based upon allowing a requested action provided in conjunction with the access request.

3. The method of claim 1 wherein the resource is associated with an owner, and further comprising, receiving another request from a non-owner user who is in the same user role as the owner, determining that the non-owner user is not a user who corresponds to the set of one or more receiving entities granted shared access to the resource, and denying access to the resource to the non-owner user.

4. The method of claim 1 wherein the resource is associated with an owner, and further comprising, receiving another request from the owner, and allowing the owner to access the resource.

5. The method of claim 4 further comprising, associating information with the owner indicative of whether the owner is permitted to share the resource.

6. The method of claim 5 wherein associating the information is based upon receiving the information for a user role to which the owner belongs, and wherein the information indicates whether the owner is permitted to share all owned resources, or share no owned resources.

7. The method of claim 1 further comprising, associating information with a receiving entity indicative of whether the receiving entity is permitted to receive shared access to the resource.

8. The method of claim 7 wherein associating the information is based upon receiving the information for a user role corresponding to the receiving entity, and wherein the information indicates whether the receiving entity is permitted to receive shared access to all shared resources, or to no shared resources.

9. The method of claim 4 further comprising, associating information with the owner indicative of whether the owner is permitted to share the resource, and associating information with a receiving entity indicative of whether the receiving entity is permitted to receive shared access to the resource.

10. The method of claim 1 wherein the resource is associated with an owner, and further comprising, preventing the user from sharing the resource access with another user.

11. In a computing environment, a system comprising, a role based access system comprising a data store configured to maintain role based information, including relationships between user roles, members, allowed resource actions, and allowed resource scopes, the role based access system further including owner information associated with at least one resource that identifies whether that resource has an owner, and if so, an owner identifier, and sharing information associated with at least one resource that identifies any receiving entity or entities having shared access to that resource, the role based access system further including an authorization manager configured to evaluate any owner information and sharing information associated with a resource to determine whether to grant requested access to a resource.

12. The system of claim 11 wherein when a request to access a resource to perform an action is received with respect to a resource that has an associated owner, the authorization manager grants access to perform the action if the action is allowed and if the request corresponds to the owner or to a user that has shared access to the resource via the sharing information, otherwise the authorization manager denies access.

13. The system of claim 11 further comprising a user interface configured to receive data to associate owner information with a resource.

14. The system of claim 11 further comprising a user interface configured to permit or prevent an owner from sharing owned resources, or permit or prevent a receiving entity from received shared access to resources, or both permit or prevent an owner from sharing owned resources and permit or prevent a receiving entity from received shared access to resources.

15. The system of claim 11 wherein the owner of a resource determines which receiving entity or entities, if any, have shared access to the resource.

16. The system of claim 11 wherein the owner of a resource determines a receiving entity that has shared access to the resource, and wherein the authorization manager is configured to prevent the receiving entity that has shared access to the resource from further sharing the shared resource.

17. The system of claim 11 wherein the role based access system provides for isolation of a resource, including by only allowing access to an owner of the resource or an administrator when no receiving entity is identified in the sharing information.

18. The system of claim 11 wherein the role based access system provides for sharing of a resource, including by allowing access to an owner of the resource or user corresponding to a receiving entity identified in the sharing information.

19. One or more computer-readable media having computer-executable instructions, which when executed perform steps of a process, comprising,
(a) receiving a request from a user to access a resource in a role based access system, the request identifying a requested action;
(b) determining based on a role of the user whether the user can perform the requested action, and if not, denying the request and advancing to step (e);
(c) determining whether the user is an associated owner, and if so, granting access to allow the action to be performed on the resource and advancing to step (e);
(d) determining whether the user corresponds to any receiving entity to which access is shared, and if not, denying the request and advancing to step (e), and if so, granting access to allow the action to be performed on the resource and advancing to step (e); and
(e) ending the process.

20. The one or more computer-readable media of claim 20 having further computer-executable instructions, comprising, building a list of zero or more receiving entities to which access is shared, including allowing an owner to add an entity to the list if the owner is permitted to share resources and if the entity is permitted to receive shared resources.
